(19) United States
(12) Patent Application Publication
(10) Pub. No.: US 2010/0133808 A1
(43) Pub. Date: Jun. 3, 2010

(54) METALLIC CONNECTOR, ASSEMBLY AND METHOD OF ASSEMBLY

(75) Inventors: Claudio Maria Castiglioni, Varese (IT); Carlo Moralli, Musso (Como) (IT)

Correspondence Address: BUCHANAN, INGERSOLL & ROONEY PC, POST OFFICE BOX 1404, ALEXANDRIA, VA, 22313-1404, US

(73) Assignee: AFL Sp.A., Dongo (CO) (IT)

(21) Appl. No.: 12/447,631

(22) PCT Filed: Oct. 29, 2007
(86) PCT No.: PCT/IB07/03258

§ 371 Date: Jan. 4, 2010

(30) Foreign Application Priority Data
Oct. 30, 2006 (IT) MI2006A002078

(51) Int. Cl. F16L 33/18; F16L 13/14

(52) U.S. Cl. 285/108; 29/508

(57) ABSTRACT

A metallic connector (1) comprises a female housing (2) in which a retaining ring (6) is made of a material which is harder than the female housing (2) so that the retaining ring (6) is urged into the inner wall of the female housing during a pressing operation. An annular sealing member (7) provides a water tight seal. In the connection assembly, the retaining ring (6) deforms an end of a metallic item (4) provided within the female housing to connect the female housing to the metallic item. The connection assembly is formed by a pressing operation which causes—the retaining ring (6) to deform both the female housing (2) and the metallic item (4) to be connected.

### FIELD OF THE INVENTION

The present invention relates generally to metallic connectors which are intended to be used to join metallic parts together by deformation.

In one embodiment, the invention comprises a metallic connector for connection to a metallic pipe or to provide a connection between two or more metallic pipes.

In another embodiment, the invention comprises an assembly comprising a metallic element, which is preferably tubular, that is joined to a metallic connector, and a method of assembly.

### BACKGROUND OF THE INVENTION

In the building trade, it is well known that piping is used to distribute various fluids such as water and gas. Such piping typically comprises sections of rigid metal pipes, that are usually made of steel, which are threaded together using connectors, that are usually made of cast iron.

The pipes and the connectors are usually screwed together. Typically, the connector (such as an elbow, a coupling, or a T-fitting) has threads which are provided at the ends during manufacture of the connector. However, typically the pipe is first cut to the right length in the field during assembly of a piping system and then the ends of the pipe are threaded. Once the ends of the pipe have been threaded, one end of the pipe can be screwed into the connector.

This method of connecting pipes is very common, but is not particularly easy or economical. For example, a threading machine (or some other special piece of equipment) is normally used at the workplace to thread the ends of the pipes. Such threading machines are usually quite large and difficult to move.

Furthermore, once the ends of the pipe have been threaded, the threads are typically wound with Teflon or with hemp or with some other sealing material to make the joint with the connector watertight, and this procedure takes additional time during assembly of a piping system.

These steps are generally repeated for each of the sections of pipe in a piping system so that the various components may be connected in a professional manner and so that the connections are watertight and so that the piping assembly has the proper size and configuration.

The consequence is that the conventional method for connecting metallic pipes generally requires a very long time and the preparation of the threads at the pipe ends is relatively difficult. In addition, various problems such as leaks, stripped threads, and structurally weak connections may arise if a pipe has not been threaded properly.

In a prior art patent document (WO-03058108), the suggestion was made to connect pipes and connectors not by threading but by pressing them together. In this way, connections can be made quickly and simply due to the use of an automatic press which is positioned around the connector.

Furthermore, according to this patent document, the connection generally provides a consistent level of quality throughout various connections, since generally the only variable is the amount of pressure to be applied to the connector and this pressure is relatively constant for the same connector dimensions.

However, although the system of patent document WO-03058108 is relatively innovative and simple, there are still various difficulties and disadvantages provided by such a system. For example, in this system, the length of the pipe is understood to be relatively important and in certain conditions during assembly of a piping system it may be appropriate that a pipe having a greater (or shorter) length needs to be inserted into the connector.

### BRIEF SUMMARY OF THE PRESENT INVENTION

It is an object of a preferred embodiment of the present invention to provide a metallic connector which may be connected with the end of a metallic item—preferably a pipe—in a manner which is relatively simple, rapid, and watertight, in order to avoid problems found with traditional connectors.

It is another object of a preferred embodiment of the present invention to provide a connection in which a metallic part—preferably a pipe or tubular member—is connected with a metallic connector to provide a connection which is relatively simple, rapid, and watertight, in order to avoid problems found with traditional connection arrangements.

It is yet another object of a preferred embodiment of the present invention to provide a method for assembling a connection in which a metallic part—preferably a pipe or tubular member—is connected with a metallic connector to provide a connection which method is relatively simple, rapid, and watertight, in order to avoid problems found with traditional connection methods.

### BRIEF DESCRIPTION OF THE FIGURES

FIG. 1 is a perspective view in partial cross-section of a straight connector according to a preferred embodiment and two pipe members before insertion into the straight connector.

FIG. 2 is a side view in partial cross section of the straight connector and the two pipe members of FIG. 1.

FIG. 3 is a side view in cross section of the straight connector and the two pipe members of FIG. 1 after the pipe members have been joined with the straight connector.

FIG. 4 is a side view in cross section of the straight connector of FIG. 1, with certain parts omitted.

FIG. 5 is a side view in cross section of an elbow connector according to a preferred embodiment.

FIG. 6 is a side view in cross section of a T-connector according to a preferred embodiment.

FIG. 7 is a side view in cross section of another straight connector according to another preferred embodiment.

FIG. 8 is a top view of a tool for use with the connectors of FIGS. 1-7.

### DETAILED DESCRIPTION OF THE PREFERRED EMBODIMENTS

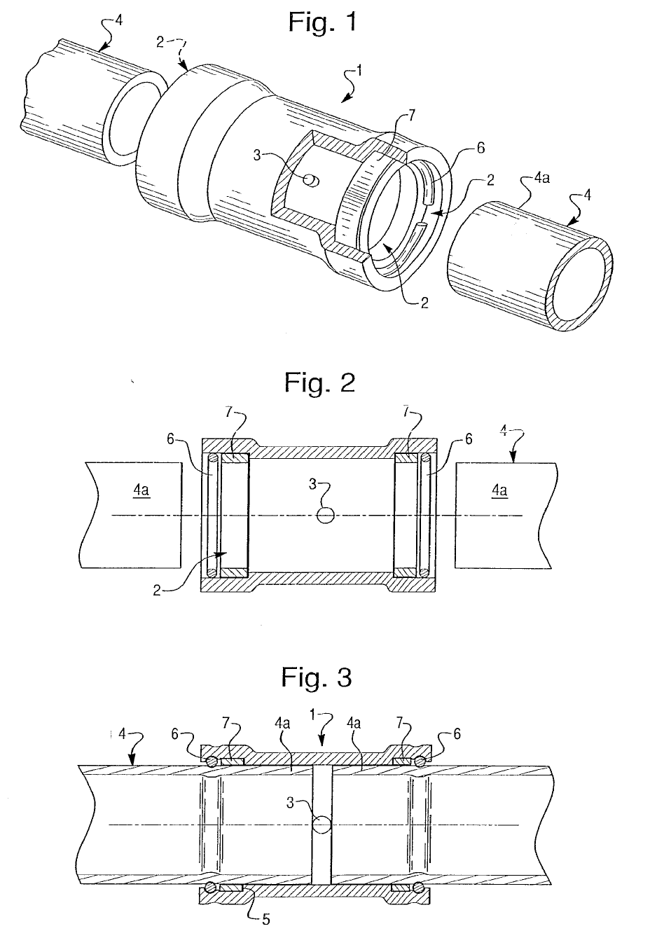

With reference to FIG. 1, a metallic connector 1 in accordance with a preferred embodiment of the invention is provided in order to connect a first end 4a of a metal pipe 4 with a first end of another metal pipe 4. Although the metallic connector may be used to connect items other than metal pipes, in the preferred embodiments, the metallic connector is used to connect to one or more pipe ends. The ends 4a of the metal pipes 4 are each to be connected to the metallic connector 1 by pressing ends of the metallic connector 1 after the ends 4a of the metal pipes 4 have been inserted into the metallic connector 1 so that the metallic connector and the ends 4a of the metal pipes 4 are pressed together.

The metal connector 1 comprises a body with at least one female housing 2. The female housing is formed by an inner wall which is configured to receive the end section 4a of the metal pipe 4 to be connected.

In the preferred embodiments as shown in the Figs., the metal pipe 4 which is to be connected to the metallic connector 1 preferably has a substantially circular cross-section. Similarly, the female housing 2 of the metallic connector 1 also has a substantially circular cross-section.

With continued reference to FIG. 1, the drawing of the metallic connector 1 is partially cut away at an end of the metallic connector to illustrate the configuration of the female housing 2.

With reference now to the items seen in FIGS. 1 to 4, (which are generally illustrated in side cross section), the metallic connectors are basically cylindrical in shape and hollow on the inside, such that they can be defined as having an open cylindrical axis at either end.

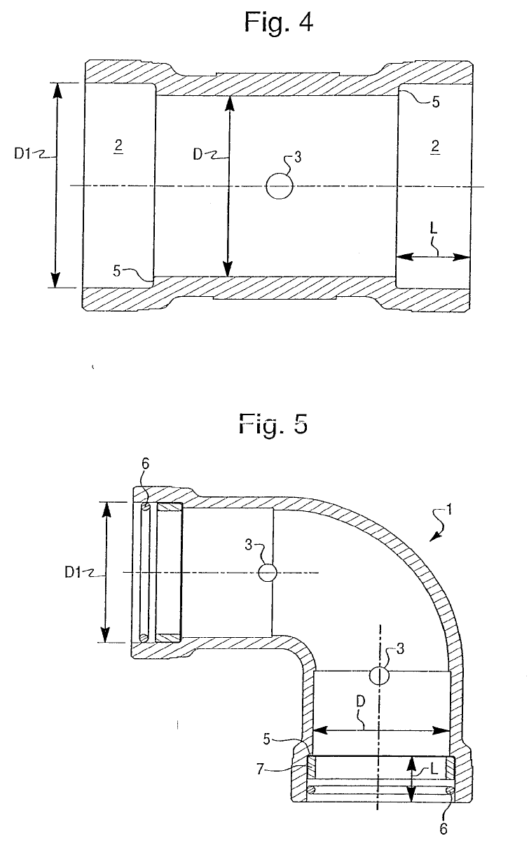

With specific reference to FIG. 4, the metallic connector 1 has an inner diameter D which is more or less equal to or slightly larger than the external diameter of the end of metal pipe 4, such that the end of the metal pipe 4 may be inserted into the end of the metallic connector 1 and a connection may be made between the end of the metallic connector 1 and the end 4a of the metal pipe 4 with relatively little play. Preferably, after assembly, the end 4a of the metal pipe 4 has as little play as possible in the metallic connector 1.

Preferably, at least a specified length L of either end of metal pipe 4 (comprising the end section 4a) can be inserted into the basically cylindrical body of female housing 2. The specific length L corresponds to the axial length of a portion of the female housing having a diameter D1 which is slightly greater than the inner diameter D of the connector.

In the preferred embodiments, the metallic connector 1 includes extensions or stops 3 which are provided on or form part of an inner wall of the metal pipe 1. These extensions serve as stops to prevent the metal pipe 4 from being inserted too far into the metallic connector. As can be seen from the Figs., the stops 3 are positioned so that they are further inside the metallic connector 1 than the minimum length L of pipe which is to be inserted into the female housing 2. When these stops 3 are reached by the length of pipe 4, at least the minimum length L of the metal pipe 4 has been inserted into the female housing 2.

With reference to FIG. 3, it may be preferable to insert the ends of the metal pipes 4 into the respective female housings of the metallic connector 1 until the ends of the metal pipes 4 abut the stops 3. In this way the assembler is assured that at least the minimum length L of the metal pipes 4 have been inserted into the respective ends of the metallic connector 1.

With reference again to FIG. 4, according to a preferred embodiment, each female housing 2 of the metallic connector 1 comprises an internal radial bushing or shoulder 5. The radial bushing or shoulder 5 is formed by the reduction in the internal diameter D1 of the outermost end of the female housing 2 to the smaller diameter D of the next portion of the metallic connector 1 which, as detailed above, is more or less equal to or slightly larger than the external diameter of the metal pipe 4.

A significant feature of the preferred embodiments of the present invention is that an end of the metallic connector 1 will have a retaining ring 6, which—
is situated in the female housing 2 so as to permit (i.e. not obstruct) the insertion into the female housing of the end section 4a of the pipe 4; and,
is made of a material which is at least slightly harder than the material of the wall of the pipe so that, during deformation by pressing in the female housing of the metallic connector 1 and the end section 4a of the pipe 4 which is inside the female housing 2, the retaining ring 6 will deform the outer wall of the end section 4a and, at the completion of the pressing operation, is slightly inserted into the outer wall of the end section 4a of the metal pipe.

Significantly, at the completion of the connecting operation by pressing in and deforming the female end of the metallic connector 1 and the end section 4a of the pipe 4, the retaining ring 6 is pressed very hard against the external wall of the end section 4a of the pipe 4, such that the end section 4a of the pipe 4 is held very firmly in place inside the female housing 2, and therefore inside the metallic connector 1.

The retaining rings 6 are preferably made of harder material than the material of the pipes or piping 4, so that during the deformation operation of the metallic connector 1 and the end section 4a of the pipe 4, the aforementioned retaining ring 6 also deforms the end section 4a of the pipe 4 and makes a slot about a circumference of the pipe end section 4a and the retaining ring is slightly inserted into the wall of the pipe 4. This means that the pipe 4 will be firmly connected to the metallic connector 1.

According to the preferred manufacturing method, the aforementioned retaining ring comprises only a portion of a complete ring. In other words, the retaining ring is preferably open, i.e. with a cut or gap provided somewhere along its circumference (see, FIG. 1). The angular extent of the cut depends upon the size of the opening in the female housing of the metallic connector 2 and the relaxed diameter of the retaining ring 6. During insertion of the retaining ring 6 into the female housing of the metallic connector 1, the retaining ring may be uncompressed or may be slightly compressed to facilitate maintaining the retaining ring in the female housing. The cut or gap in the retaining ring is preferably large enough so that after the female end 2 of the metallic connector 1 has been compressed about the end 4a of the metal pipe 4, the annular ring still has at least a slight cut or gap. Of course, since the retaining ring is cut and preferably does not form a complete circle even after the deformation step is completed, the slot preferably does not extend through a complete 360° about the pipe end.

As shown in the preferred embodiments, the retaining ring 6 has an inner diameter so that (before the female end of the metallic connector 1 is compressed), the retaining ring will readily fit around the end 4a of the metal pipe 4. Preferably, the retaining ring is made of stainless steel.

The retaining ring 6 is preferably slotted firmly into the female housing 2, at a certain distance from the internal radial bushing or shoulder 5 at the end of the female housing. Forcing the open retaining ring 6 into the female housing 2 (i.e., by compressing the diameter of the retaining ring during insertion into the female housing 2), facilitates that the retaining ring 6 will be positioned properly inside the female housing 2, and also facilitates that the retaining ring 6 will not accidentally fall out from the metallic connector 1 when the end section 4a of the pipe 4 is inserted into the female housing. To keep the retaining ring 6 properly in place inside the female housing 2, an internal radial bushing (or preferably four internal radial bushes spaced apart by ninety degrees) are made generally at the outermost end of the inside of the female housing. An advantage of this internal radial bushing arrangement is that it can be made by caulking at staggered locations about the end of the housing, which are positioned ninety degrees apart. Of course, if six caulking locations are provided, the locations will be sixty degrees apart.

The caulking locations may be provided by punching a series of slots at the opening of the female housing of the metallic connector.

Another aspect of the preferred embodiments is that an annular seal member 7 is provided axially between the internal radial bushing or shoulder 5 and the retaining ring 6. The shoulder 5 keeps the annular sealing member 7 from being pushed into the metallic connector upon insertion of the pipe end. The annular seal member 7 forms a watertight connection with the outer surface of the end 4a of the metal pipe 4 and the inner surface of the female housing 2 of the metallic connector 1, after the female housing has been compressed about the end of the metal pipe.

The outer circumference wall of this annular seal member 7 is preferably in contact with the inside wall or inner surface of the female housing 2 and the inner circumference wall of the annular seal member 7 is preferably in contact with the outer wall or outer surface of the end section 4a of the pipe 4. Although the outer circumference wall and the inner circumference wall of the annular seal member 7 are curved in the circumferential direction, the walls are preferably relatively flat in the axial direction so that contact between the walls and the respective surfaces of the female housing and pipe end is better. The annular seal member 7 preferably has an axial length which is several times longer than the thickness of the retaining ring 6 (see, FIGS. 1 and 2). The annular seal member 7 may be made by cutting an axial section of a circular-section tube or pipe which is made from a suitable, proper material (such as Teflon, rubber, or some similar material providing appropriate sealing characteristics).

Significantly, the internal radial bushing or shoulder 5 and the open or cut retaining ring 6 hold the annular seal member 7 in a proper position with regard to the female housing 2, both before and after the insertion of the end section 4a of the pipe 4 in the metallic connector 1, as well as after the deformation operation has been completed. The metallic connector 1 is preferably made of cast iron, which is relatively inexpensive. Preferably, after being formed, the metallic connector 1 is heat-treated so that it is tensile and ductile enough to allow the deformation operation to be carried out properly.

The metallic connector 1 is preferably made of malleable white heart cast iron (UNI EN 1562) with a maximum percentage chemical composition preferably of: C 0.20%; Si 0.95%; Mn 0.65%; P 0.05%; S 0.20%. The mechanical properties of the malleable white heart cast iron are preferably: Rp_{0.2} [MPa] 220; Rₘ [MPa] 400; and A min. 5%. White heart malleable cast iron is preferred because of its ability to be deformed without cracking. The cast iron connectors are preferably subjected to a suitable heat treatment under a controlled atmosphere and at an appropriate high temperature to provide an appropriate decarburization and malleability.

The metal connector preferably has a galvanized zinc coating provided by hot dip technology. The zinc coating is provided after the metallic connectors have been cleaned and washed in chloride acid and a phosphoric solution. The metallic connectors are dipped in a basin with melted zinc which is preferably 99.99% pure at a temperature of more than 600° C. The zinc coating will preferably completely cover the inside and outside of the metallic connector 1 to prevent oxide corrosion. After the zinc coating has been provided, the metallic connector will be provided with the annular seal member 7 and the retaining ring 6 which are preferably kept in place by the caulking bushings or shoulders provided at the outer (inside) end of the female housing.

The pipe to be connected to the metallic connector 1 is preferably formed of steel tube such as S 195T Number 1.0026 (EN 10255 Norm). The maximum percentage chemical composition of the piping is preferably: C 0.20%; Mn 1.40%; P 0.035%; S 0.030%. The mechanical properties of the piping are preferably: Rp_{0.2} [MPa] 195; Rₘ [MPa] 320-520; and A min. 20%.

The annular seal member 7 is preferably of an elastomer such as EPDM which has a working temperature range of −20° C. to 110° C. and a working pressure maximum of 25 bar at a temperature of 20° C. and 16 bar at a temperature of 100° C. These annular sealing members are suitable for use in sanitary plumbing, heating, air conditioning, fire protection and air compression piping systems.

The annular seal member 7 preferably has a radial thickness which is slightly greater than the radial thickness of the retaining ring 6 so that the annular sealing member is compressed when the female housing 2 is compressed about the end 4a of the metal pipe 4.

The cut retaining rings 6 are preferably made of stainless steel such as AISI 316L.

With reference now to FIG. 7, in piping systems for use with the supply of heating gas for combustion, an additional annular ring 12 made of copper is preferably provided adjacent the retaining ring 6. The annular ring 12 of copper preferably has a radial thickness which is slightly greater than the radial thickness of the retaining ring 6 so that the annular ring 12 of copper is deformed during the compression of the female housing. In this way, the annular ring 12 of copper provides a seal between the inner surface of the female housing 2 and the outer surface of the end 4a of the metal pipe 4 for use in supplying combustible gas.

In piping systems for supplying heating gas for combustion, the annular sealing member 7 is preferably formed of an appropriate elastomer such as HNBR which has a working temperature range of −20° C. to 70° C. and a working pressure maximum of 5 bar.

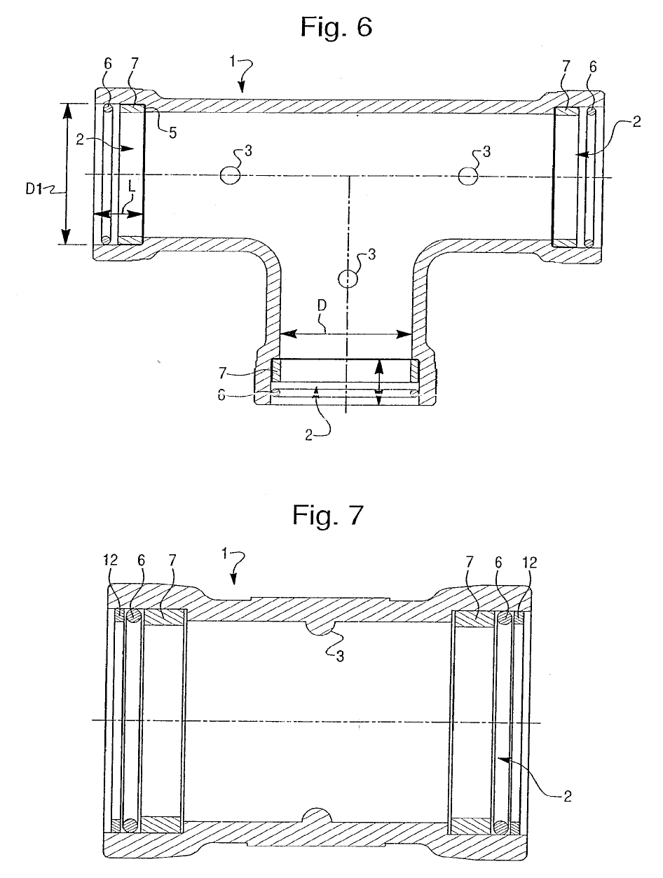

With reference now to FIG. 5, the metallic connector 1 in this drawing is a 90° elbow fitting. In FIG. 6, the metallic connector 1 is a T-fitting. The configuration of the female housing at the ends of the 90° elbow and at the ends of the T-fitting are configured the same as the female housing at the ends of the metallic connector 1 of FIGS. 1-4. If the 90° elbow and the T-fitting of FIGS. 5 and 6 are to be used in connection with piping for combustible gas, then the female housings are preferably configured the same as the female housing at the end of the metallic connector 1 of FIG. 7 by providing an annular ring 12 of copper outside of the retaining ring 6.

With reference to FIG. 5 and FIG. 6, a stop or stops 3 may be provided for each female housing of the elbow and T-fitting. In the case of a straight fitting, the same stop or stops 3 may be appropriate for both ends of the fitting (see FIGS. 1-4 and 7).

As can be appreciated by one of ordinary skill in the art upon reading the detailed description of the preferred embodiments, the metallic connector according to the present invention can be essentially any shape, and, if desired, can have one or more ends which are configured as shown in FIGS. 1-7 and one or more ends which are configured according to the prior art. For example, one or more of the ends of a metallic connector according to the present invention may be threaded while one or more of the other ends of the metallic connector may be arranged with a female housing 2, retaining ring 6, an annular seal member 7, and other characteristics as detailed above.

Similarly, metallic connectors comprising the female housing according to the preferred embodiments of the present invention may have one end which is reduced in size (such as a reduced press elbow), or may have one end which is provided with either male threads or with female threads. In addition, the part to be connected to the metallic connector may be a nipple reducer with or without male or female threads, or a union fitting. Other plumbing fittings are, of course, suitable for use with the metallic connector according to the preferred embodiments of the present invention.

During assembly of a piping system, the elongation or contraction of the piping due to temperature variation should be taken into account as in the conventional piping systems such as those using threaded couplings. The pipe ends should be cut squarely and deburred to remove any debris prior to insertion into the female housing. If desired, a lubricant such as a silicon lubricant spray may be provided on the pipe end or inside the female housing.

If desired, the retaining ring 6 can be inserted into the female housing in some other way than that which is described above, and the open ring can also be maintained in the female housing in another way (for example, other than by the use of caulking).

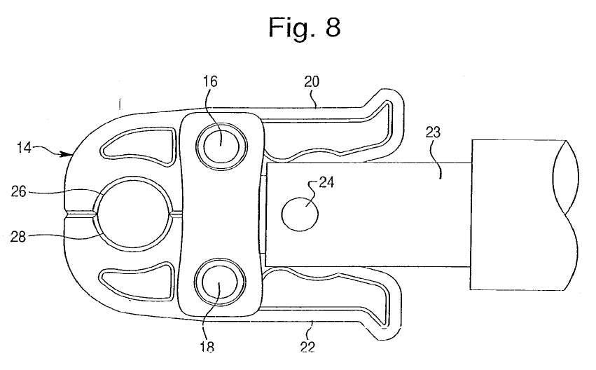

With reference to FIG. 8, a pressing jaw 14 for use with the metallic connectors of the preferred embodiments is shown. In the pressing jaw 14, first and second jaw halves 20, 22 are arranged for movement about respective pivots 16, 18. The first and second jaw halves 20, 22 when closed form a circular opening by the semi-circular portions 26, 28. A press member 23 is attached to the jaws 14 at the member 24 and the press member urges the jaw halves 20, 22 apart to urge the semi-circular portions 26, 28 together.

During assembly of a piping system, the female housing of the metallic connector 1 with the end of the pipe positioned within the female housing is positioned between the semi-circular portions 26, 28 of the jaw halves 20, 22. Then the distal ends of the jaw halves 20, 22 are urged apart by the press member to urge the semi-circular portions 26, 28 together and thereby compress the female housing of the metallic connector 1.

The press machine is preferably of suitable, conventional configuration and preferably has a minimum pressing force of 32 kN for piping sizes up to 1 inch.

Accordingly, when assembling a pipe joint comprising a metallic connector 1 and a pipe 4, the following stages may be applied—
prepare a metallic connector 1 with at least one female housing 2, inside which an annular seal member 7 and a cut or open retaining ring 6 have been inserted;
insert the end section 4a of the pipe 4 into the female housing 2, until the pipe end reaches the stop or stops 3 provided within the metallic connector; and,
compress and deform the metallic connector at the female housing an automatic press with jaws capable of completely encircling the circumference of the connector to be pressed, and ensure that the jaws close around the relative section of piping.

Preferably, the jaws are provided with a raised feature on the semi-circular portions 26, 28 which will provide a visible marking on the outside of the female housing when the deformation is properly performed. This marking may comprise a dimple inserted into the female housing outer surface by the pressing jaws. If necessary, the pressing operation may be repeated on the same female housing without a likely damage to the metallic connector or to the pipe end. After compression, it may be possible to slightly rotate the metallic connector relative to the pipe end without harming the connection and without impairing the seal of the metallic connector with the pipe end.

The deformation of the female housing reduces the circumference of the female housing and results in the circumference of the retaining ring being reduced. In addition, the retaining ring deforms the inner wall of the female housing and the retaining ring is partially inserted into the inner wall of the female housing 2. At the same time, the retaining ring 6 deforms the outer wall of the end of the pipe and the retaining ring will be inserted slightly by deformation into the outer wall of the end section 4a of the pipe 4, thus locking the metallic connector and the pipe end together.

In addition, the compression of the female housing compresses the annular seal member 7 between the female housing and the pipe end to provide a water tight seal. If a copper annular ring is provided, the compression of the female housing also compressed the copper annular ring to form a gas tight seal between the female housing and the pipe end.

An assembly is thus obtained comprising a metallic connector 1 and a section of piping 4, which are locked together and relatively inseparable.

In the event of the metallic connector having one or mere additional ends which are to be connected in the same way, the above operations need only be repeated on the remaining female housings. It is easy enough to understand from the details above that the metallic connector in this invention is a solution to the technical problems for which this invention was designed, and at the same time the problems found with traditional methods. One advantage of the metallic connector in this invention is the structural simplicity with which it has been designed.

Clearly workmen in this field, when trying to comply with the specifications they have been given, may make all the changes they want to the connector and the various units as described above, for all of which there is protection as detailed in the claims below.

For example, the seals and retaining ring may be applied directly to the end of a pipe or another metallic item to be joined to the metallic connector, and then the female housing (without an annular sealing member and a retaining ring) may be positioned over the pipe end (having the annular seal member and the retaining ring) and then the female housing may be compressed as described above.

While the invention has been described in detail with reference to specific embodiments thereof, it will be apparent to one skilled in the art that various changes and modification may be made, and equivalents thereof employed, without departing from the scope of the claims.

1. A metallic connector for connecting an end of a steel pipe by deformation, wherein the metallic connector comprises a female housing, made of white heart malleable cast iron material and which has been subjected to heat treatment so it is tensile and ductile enough to allow deformation without cracking, which defines an inner wall which is adapted to receive the end of the steel pipe to be connected,
a retaining ring which is provided within the female housing, the retaining ring adapted to receive the end of the steel pipe to be connected, the retaining ring being made of a material which is harder than the white heart malleable cast iron material used to make the inner wall of the female housing of the metallic connector, so that the retaining ring can deform the inner wall of the female housing of the metallic connector and be partially inserted therein after a pressing operation during which the female housing is joined to the end of the steel pipe to be connected.

2. A metallic connector according to claim 1, wherein the metallic connector further comprises an annular seal member which is provided within the female housing to provide a watertight seal between the inner wall of the female housing of the metallic connector and the end of the steel pipe to be connected.

3. A metallic connector according to claim 1, wherein the annular seal member has an outer wall which abuts the inner wall of the female housing and wherein the annular seal member has an inner wall which abuts an outer wall of the end of the steel pipe to be connected, said outer wall of the annular seal member being generally circular about an outer circumference of the annular seal member and being generally flat along an axial direction, said inner wall of the annular seal member being generally circular about an inner circumference of the annular seal member and being generally flat along an axial direction.

4. A metallic connector according to claim 1, wherein a shoulder is provided within the female housing, the shoulder and the retaining ring together maintaining the annular seal member in a desired position within the female housing.

5. A metallic connector according to claim 1, wherein the retaining ring is forced into the female housing to maintain the retaining ring in the female housing.

6. A metallic connector according to claim 1, wherein the retaining ring does not form a complete circle.

7. A metallic connector according to claim 5, wherein the retaining ring has first and second ends, the first and second ends forming a gap in said retaining ring.

8. A metallic connector according to claim 7, wherein the retaining ring is generally circular.

9. A metallic connector according to claim 8, wherein the female housing is tubular.

10. (canceled)

11. A metallic connector according to claim 1, wherein the metallic connector is joined to the end of the steel pipe by coupling, with the retaining ring being partially inserted into the inner wall of the female housing by deformation of the inner wall during the pressing operation during which the female housing is joined to the end of the steel pipe, and locked in place by being pressed very hard against the end of the steel pipe to hold the steel pipe firmly in place in the female housing of the metallic connector.

12. A metallic connector according to claim 11, wherein the steel pipe has a hardness which is less than that of the material used for the retaining ring, whereby after the pressing operation, the retaining ring is inserted partially into the outside wall of the steel pipe.

13. A metallic connector according to claim 12, wherein the end of the steel pipe comprises a male member for insertion into said female housing of the metallic connector with complementary profiles.

14. A metallic connector according to claim 13, wherein the female housing is tubular, and the end of the steel pipe is tubular.

15. A metallic connector according to claim 14, wherein the female housing and the end of the steel pipe each has a transverse cross-section which is generally circular.

16. A method for assembling a connector unit, comprising the steps of:
providing a metallic connector made of white heart malleable cast iron material and which has been subjected to heat treatment so it is tensile and ductile enough to allow deformation without cracking, for connecting an end of a steel pipe by deformation, the metallic connector comprising a body comprising a female housing which defines an inner wall which is adapted to receive the end of the steel pipe to be connected;
inserting the end of the steel pipe into the female housing of the metallic connector;
providing a retaining ring between the female housing and the end of the steel pipe, the retaining ring being adapted to receive the end of the steel pipe to be connected, the retaining ring being made of a material which is harder than the white heart malleable cast iron material used to make the inner wall of the female housing and pressing the female housing of the metallic connector so as to cause a partial insertion of the retaining ring into the inside wall of the female housing by deformation of the inside wall, and to cause the retaining ring to apply a pre-determined force to the outside wall of the end of the steel pipe to be connected and to ensure that the steel pipe is held tightly in the metallic connector.

17.-20. (canceled)

21. A metallic connector according to claim 4, wherein a relaxed diameter of the retaining ring is reduced by compression while the retaining ring is being inserted into the female housing.

22. A metallic connector according to claim 21, wherein the retaining ring is made of stainless steel wire and does not form a complete circle.

23.-26. (canceled)

27. A metallic connector according to claim 1, wherein the retaining ring is made of stainless steel.

28. A metallic connector according to claim 27, an annular ring of copper is provided adjacent the retaining ring.

29.-30. (canceled)
